(19) United States
(12) Patent Application Publication
(10) Pub. No.: US 2018/0249132 A1
(43) Pub. Date: Aug. 30, 2018

(54) VEHICLE IMAGING SYSTEM AND METHOD

(71) Applicant: Jaguar Land Rover Limited, Coventry, Warwickshire (GB)

(72) Inventors: Jeremy GREENWOOD, Coventry (GB); Howard SISWICK, Coventry (GB); Mike ALLEN, Coventry (GB)

(21) Appl. No.: 15/756,453

(22) PCT Filed: Jul. 18, 2016
(86) PCT No.: PCT/EP2016/067042

§ 371 Date: Feb. 28, 2018

(30) Foreign Application Priority Data
Sep. 2, 2015 (GB) 1515526.0

(51) Int. Cl. H04N 7/18; B60R 1/00; G01S 5/02; G01S 5/14

(52) U.S. Cl. CPC H04N 7/185; H04N 7/188; B60R 1/00; G01S 5/0247; B60R 2300/8066; B60R 2300/105; B60R 2300/303; B60R 2300/406; G01S 5/14

(57) ABSTRACT

The present disclosure relates to a vehicle imaging apparatus (2) having a location determining module (10) for determining the relative location of a remote imaging apparatus (3). The location determining module (10) is configured to receive a tracking signal (S2) from a remote transmitter (16) associated with the remote imaging apparatus (3). An image receiver module (7) is provided to receive image data (DT) transmitted by the remote imaging apparatus (3). At least one image processor (5) is provided to process the image data (DT) in dependence on the determined location of the remote imaging apparatus (3). The present disclosure also relates to a remote imaging apparatus (3) for mounting to a trailer (T). The remote imaging apparatus (3) having a camera (CT); and an image transmitter (14) for transmitting image data (DT) generated by the camera (CT). A tracking module (15) is disposed on the remote imaging apparatus (3) to enable the relative location of the remote imaging apparatus (3) to be determined. The tracking module (15) has a remote transmitter (16) configured to transmit a tracking signal (S2) to a location determining module (10). The disclosure also relates to a vehicle imaging system (1) including a vehicle imaging apparatus (2) and a remote imaging apparatus (3).

### TECHNICAL FIELD

The present disclosure relates to a vehicle imaging system and method. More particularly, but not exclusively, the present disclosure relates to a vehicle imaging apparatus for use with a remote imaging apparatus; to a remote imaging apparatus having a tracking module; to a method of modifying image data; to a vehicle; to a trailer; and to a rig comprising a vehicle and a trailer.

### BACKGROUND

It is known to provide a vehicle with one or more camera, typically an optical camera, to aid driver visibility. By way of example, it is known to provide one or more camera at the rear of the vehicle to allow the vehicle driver to view obstacles while reversing. To facilitate reversing of a trailer coupled to the vehicle, one or more camera may be disposed on the trailer. A composite image may be generated by combining the images from a plurality of cameras. In order to combine multiple images, it is necessary to know the relative location of the cameras. However, the relative location of the camera on the trailer may not be known, for example if the camera is retrofitted to the trailer. This presents particular problems when attempting to combine images generated by cameras on the vehicle and the trailer. Image matching techniques can be used but these may be inadequate in situations where the image content is complex or low contrast.

It is against this backdrop that the present invention has been conceived. At least in certain embodiments the present invention seeks to overcome or ameliorate at least some of the shortcomings associated with prior art systems.

### SUMMARY OF THE INVENTION

Aspects of the present invention relate to a vehicle imaging apparatus; to a remote imaging apparatus; to a method of modifying image data; to a vehicle; to a trailer; and to a rig.

According to a further aspect of the present invention there is provided a vehicle imaging apparatus comprising:
a location determining module for determining the relative location of a remote imaging apparatus, the location determining module being configured to receive a tracking signal from a remote transmitter associated with the remote imaging apparatus;
an image receiver module for receiving image data transmitted by the remote imaging apparatus; and
at least one image processor for processing the image data in dependence on the determined location of the remote imaging apparatus. The location determining module may determine a lateral location and/or vertical location of the remote imaging apparatus. The image processor may modify the image data based on the determined location of the remote imaging apparatus. The image processor can apply corrections to the image data, for example to correct for an offset in the relative location of the remote imaging apparatus. The location determining module determines the location of the remote imaging apparatus relative to the vehicle imaging apparatus.

The remote transmitter may be integrated into the remote imaging apparatus. Alternatively, the remote transmitter may be a separate device which may be disposed proximal to the remote imaging apparatus. The remote transmitter may, for example, be incorporated into an electronic key (such as a key fob) associated with the vehicle. The electronic key may be used to control locking/unlocking of the vehicle and/or activating the vehicle ignition. The electronic key may be temporarily mounted to the remote imaging apparatus, for example located in a chamber or a slot formed therein.

The vehicle imaging apparatus may comprise a receiver for receiving the tracking signal. The location determining module may comprise a radio frequency (RF) transceiver. The location determining module may be configured to communicate wirelessly with the remote imaging apparatus.

The vehicle imaging apparatus may be disposed in a vehicle and the remote imaging apparatus may be disposed in a trailer coupled to the vehicle. The vehicle imaging apparatus may comprise one or more vehicle-mounted camera. The remote imaging apparatus may comprise one or more trailer-mounted camera. The image processor may apply corrections to the received image data to compensate for a lateral offset and/or a vertical offset between the one or more vehicle-mounted camera and the one or more trailer-mounted camera.

The location determining module may comprise first and second vehicle-mounted receivers; wherein the location determining module comprises a signal processor for measuring time-of-flight of the tracking signal transmitted by the remote transmitter to said first and second vehicle-mounted receivers; and determining the relative location of the remote transmitter in dependence on the time-of-flight of the tracking signal transmitted to said first and second vehicle-mounted receivers. The signal processor may perform triangulation based on a measured time-of-flight of the tracking signal to said respective first and second vehicle-mounted receivers. The first and second vehicle-mounted receivers may be first and second vehicle-mounted transceiver nodes.

The signal processor may be configured to determine a lateral location of the remote transmitter in dependence on said tracking signal.

The vehicle imaging apparatus may comprise a third vehicle-mounted receiver, wherein the signal processor is suitable for measuring time-of-flight of the tracking signal transmitted by the remote transmitter to said third vehicle-mounted receiver. The third vehicle-mounted receiver may be third vehicle-mounted transceiver node. The third vehicle-mounted receiver may be vertically offset from said first and second vehicle-mounted receivers. The signal processor may be configured to determine a vertical location of the remote transmitter in dependence on the time-of-flight of the tracking signal transmitted to said first, second and third vehicle-mounted receivers. The signal processor may perform triangulation based on the measured time-of-flight of said tracking signal to said first, second and third vehicle-mounted receivers.

The at least one image processor may be configured to output the image data to a display device, such as a screen. The at least one image processor may be configured to form a composite image comprising the image data. The at least one image processor may be configured to combine the image data with image data from one or more vehicle-mounted camera. The camera may be a digital video camera and the image data may be video image data. The vehicle-mounted camera(s) may comprise a rear-facing camera or a lateral camera mounted to the vehicle. The composite image may be output to the display device.

The location determining module may be operable to determine the relative orientation of the remote imaging apparatus. When disposed in a vehicle, the location determining module may determine the relative orientation of a trailer relative to the vehicle.

The location determining module may be operable to determine a hitch angle and/or a pitch angle of the trailer relative to the vehicle in dependence on the determined relative location of the remote imaging apparatus.

According to a further aspect of the present invention there is provided a vehicle comprising a vehicle imaging apparatus as described herein. The vehicle imaging apparatus may be configured to determine the relative location of the remote imaging apparatus once the vehicle has travelled a predetermined distance. The vehicle imaging apparatus may determine the relative location of the remote imaging apparatus when the vehicle has travelled in a substantially straight line for a predetermined distance.

According to a yet further aspect of the present invention there is provided a remote imaging apparatus for mounting to a trailer, the remote imaging apparatus comprising:
a camera;
an image transmitter for transmitting image data generated by the camera; and
a tracking module comprising a remote transmitter configured to transmit a tracking signal to a location determining module to enable to the relative location of the remote imaging apparatus to be determined. The image data may be video image data.

A receiver may be provided for receiving a trigger signal, the location determining module being configured to transmit the tracking signal in dependence on receipt of said trigger signal. The trigger signal may be transmitted by a vehicle-mounted location determining module.

According to a still further aspect of the present invention there is provided a remote imaging apparatus for mounting to a trailer configured for coupling to a vehicle, the remote imaging apparatus comprising:
a camera;
an image transmitter for transmitting image data generated by the camera; and
a location determining module comprising:
   a locating receiver configured to receive at least first and second signals from respective first and second vehicle-mounted transmitters; and
   at least one processor for determining the location of the remote imaging apparatus relative to the first and second vehicle-mounted transmitters.

The at least one processor can perform triangulation in dependence on a measured time-of-flight of said first and second signals from the respective first and second vehicle-mounted transmitters. The remote imaging apparatus may transmit a trigger signal to initiate the transmission of said first and second signals.

The remote imaging apparatus may comprise at least one image processor for processing the image data. The image data may be transmitted by said image transmitter.

According to a further aspect of the present invention there is provided a trailer comprising a remote imaging apparatus as described herein.

According to a further aspect of the present invention there is provided a vehicle imaging system comprising a vehicle imaging apparatus as described herein; and a remote imaging apparatus as described herein.

According to a yet further aspect of the present invention there is provided a rig comprising a vehicle and a trailer as described herein.

According to a still further aspect of the present invention there is provided a method of modifying image data for output to a display device, the method comprising:
determining the relative location of a remote imaging apparatus;
receiving image data generated by the remote imaging apparatus; and
processing the image data in dependence on the determined relative location of the remote imaging apparatus.

The method may comprise determining the relative location of the remote imaging apparatus using first and second vehicle-mounted receivers to receive a tracking signal transmitted by a remote transmitter associated with the remote imaging apparatus. The method may comprise determining the time-of-flight of the tracking signal to the first and second vehicle-mounted receivers. The method may comprise performing triangulation based on the time-of-flight of tracking signal.

The method may comprise determining the relative location of the remote imaging apparatus using first, second and third vehicle-mounted receivers to receive a tracking signal transmitted by the remote transmitter. The method may comprise measuring a time-of-flight of the tracking signal to the first, second and third vehicle-mounted receivers. The method may comprise performing triangulation based on the time-of-flight of said first, second and third signals.

The method may comprise determining a lateral location of the remote transmitter. The method may comprise determining a vertical location of the remote transmitter.

The vehicle imaging apparatus may be disposed in a vehicle and the remote imaging apparatus may be disposed in a trailer coupled to the vehicle. The vehicle imaging apparatus may comprise one or more vehicle-mounted camera. The remote imaging apparatus may comprise one or more trailer-mounted camera. The method may comprise applying corrections to the received image data to compensate for a lateral offset and/or a vertical offset between the one or more vehicle-mounted camera and the one or more trailer-mounted camera.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present invention will now be described, by way of example only, with reference to the accompanying figures, in which:

FIG. 1 illustrates schematically a vehicle and a trailer incorporating a vehicle imaging system in accordance with an embodiment of the present invention;

FIG. 2 illustrates schematically the components of the vehicle imaging system shown in FIG. 1;

FIG. 3A illustrates schematically the implementation of the vehicle imaging system shown in FIG. 1 when the vehicle and the trailer are aligned with each other;

FIG. 3B illustrates schematically the triangulation performed by the vehicle imaging system shown in FIG. 1;

FIG. 3C illustrates schematically the implementation of the vehicle imaging system shown in FIG. 1 when the trailer is inclined at an angle relative to the vehicle.

### DETAILED DESCRIPTION

A vehicle imaging system 1 in accordance with an embodiment of the present invention will now be described with reference to the accompanying figures. The vehicle imaging system 1 is intended for use in a vehicle V towing a trailer T (referred to in combination as a rig). The vehicle V in the present embodiment is an automobile or a utility vehicle. However, it will be appreciated that the vehicle imaging system 1 may be incorporated into other types of vehicle, such as a tractor unit and a trailer.

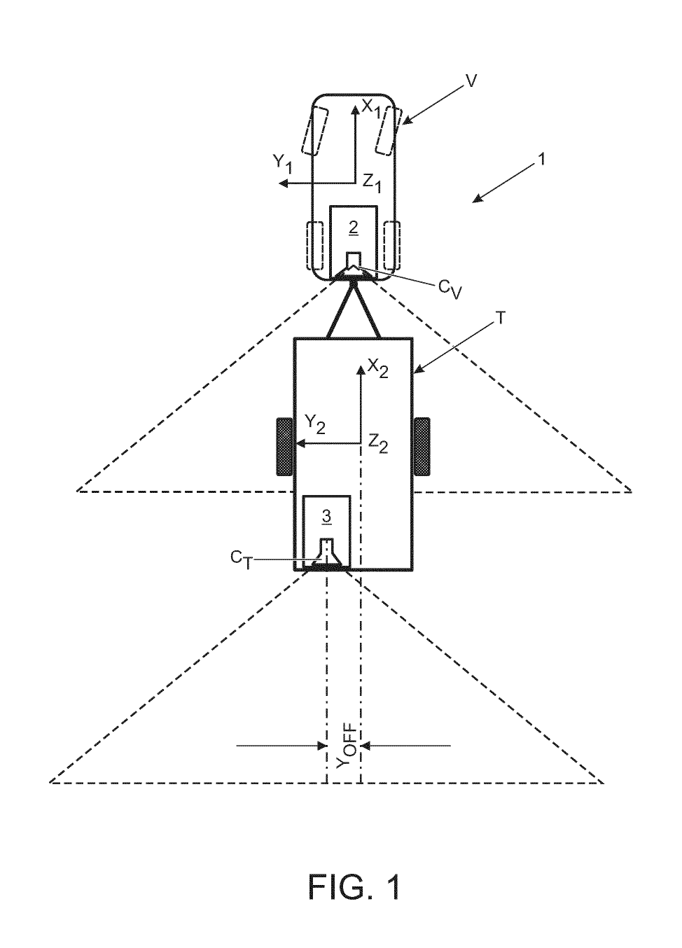

As shown in FIG. 1, the vehicle V will be described herein with reference to a first reference frame comprising a first longitudinal axis X₁, a first transverse axis Y₁ and a first vertical axis Z₁ (extending vertically out of the plane of the page). The first longitudinal axis X₁ is coincident with a centreline of the vehicle V. The trailer T will be described herein with reference to a second reference frame comprising a second longitudinal axis X₂, a second transverse axis Y₂ and a second vertical axis Z₂ (extending vertically out of the plane of the page). The second longitudinal axis X₂ is coincident with a centreline of the trailer T. The terms “front” and “rear” are used herein in their conventional sense when defining the relative position of features on the vehicle V and the trailer T. The terms “rear-facing” and “rear-view” are used herein to refer to a position or orientation which is in a direction towards the back of the vehicle V or the trailer T.

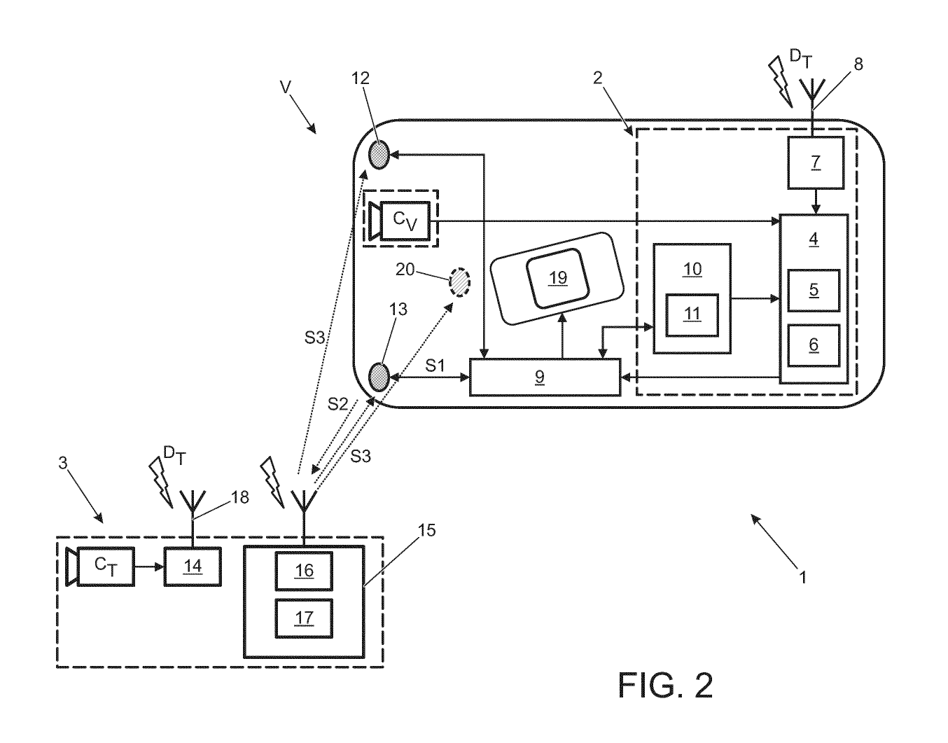

As shown in FIG. 1, the vehicle imaging system 1 comprises a vehicle imaging apparatus 2 and a remote imaging apparatus 3. As shown in FIG. 2, the vehicle imaging apparatus 2 is disposed in the vehicle V and comprises a central processing unit 4. The central processing unit 4 comprises an image processor 5 coupled to system memory 6, and an image receiver module 7. The image receiver module 7 is wireless in the present embodiment and comprises a vehicle-mounted antenna 8. The image processor 5 may be a digital image processor. The image processor 5 is configured to execute a set of software instructions held in the system memory 6. The image processor 5 is connected to a communication bus 9, such as the vehicle CAN bus, for communicating with other vehicle systems.

As shown in FIG. 2, the vehicle imaging apparatus 2 also comprises a location determining module 10 for determining the relative location of the remote imaging apparatus 3. The location determining module 10 comprises a signal processor 11 coupled to first and second vehicle-mounted transceiver nodes 12, 13. The first and second vehicle-mounted transceiver nodes 12, 13 are offset from each other along said first transverse axis Y₁. The first and second vehicle-mounted transceiver nodes 12, 13 may be configured for use in detecting an electronic key, for example as part of a vehicle Passive Entry/Passive Start (PEPS) system. Alternatively, the first and second vehicle-mounted transceiver nodes 12, 13 may be provided exclusively to determine the relative location of the remote imaging apparatus 3. The signal processor 11 is configured periodically to output an activation signal S1 to request one of the first and second vehicle-mounted transceiver nodes 12, 13 transmit a trigger signal S2. The location determining module 10 can utilise ultra-wideband (UWB) technology, for example an UWB RF signal having an operating frequency of between 3.1 GHz and 11.6 GHz since this may enable high bandwidth communications with low power consumption. A suitable operating protocol is provided under IEEE 802.17.4a. Furthermore, the sub-set of UWB frequencies designated as Band Group 6 (consisting of Bands #9, #11 and #14, ranging from 7392 MHz to 8976 MHz) can be used.

As shown in FIGS. 1 and 2, the vehicle imaging apparatus 2 comprises a vehicle-mounted camera C_{V}. In the present embodiment the vehicle-mounted camera C_{V} is in the form of an optical camera C_{V}. The vehicle-mounted camera C_{V} is disposed in a rear-facing orientation along the first longitudinal axis X₁. The vehicle-mounted camera C_{V} is mounted centrally at the rear of the vehicle V above a rear license plate (not shown) in the present embodiment. The vehicle-mounted camera C_{V} is a digital video camera operable to generate vehicle image data D_{V} corresponding to a region behind the vehicle V. The vehicle image data D_{V} is video image data in the present embodiment. The vehicle image data D_{V} is output to the image processor 5, for example over a wired connection via the communication bus 9.

As shown in FIG. 1, the remote imaging apparatus 3 is mounted to the trailer T. As shown in FIG. 2, the remote imaging apparatus 3 comprises a trailer-mounted camera CT, an image transmitter 14 and a tracking module 15. In the present embodiment the trailer-mounted camera C_{T} is in the form of an optical camera C_{T}. The trailer-mounted camera C_{T} is disposed in a rear-facing orientation at the rear of the trailer T. The trailer-mounted camera C_{T} is a digital video camera operable to generate trailer image data D_{T} corresponding to a region behind the trailer T. The trailer image data D_{T} is video image data in the present embodiment. The image transmitter 14 is configured wirelessly to transmit the trailer image data D_{T} to the vehicle imaging apparatus 2. The image transmitter 14 may transmit the trailer image data D_{T} using a suitable wireless communication standard, such as Wi-Fi®. It will be appreciated that the remote imaging apparatus 3 may be offset from the second longitudinal axis X₂ in a lateral direction, as illustrated in FIGS. 1 and 2. Thus, the vehicle-mounted camera C_{V} and the trailer-mounted camera C_{T} are offset laterally from each other (i.e. offset in a transverse direction). The image generated by the trailer-mounted camera C_{T} may be offset from the second longitudinal axis X₂. The image offset may not be evident when the image is displayed and, therefore, the image may provide a misleading representation of the relative position of an obstacle or vehicle behind the trailer T.

As shown in FIG. 2, the remote imaging apparatus 3 comprises a tracking module 15 to enable the relative location of the trailer-mounted camera C_{T} to be determined by the vehicle imaging apparatus 2. In particular, the tracking module 15 allows a static lateral offset Y_{OFF} of the trailer-mounted camera C_{T} relative to the second longitudinal axis X₂ to be determined. The image processor 5 is configured to utilise the determined static lateral offset Y_{OFF} to modify the trailer image data D_{T} to make appropriate corrections to the image generated by the trailer-mounted camera C_{T}. The tracking module 15 comprises a remote transmitter 16 and a remote receiver 17. It will be appreciated that the remote transmitter 16 and the remote receiver 17 could be combined in a transceiver. The remote transmitter 16 is coupled to a trailer-mounted antenna 18 and is configured to transmit a tracking signal S3 to the location determining module 10 in dependence on receipt of the trigger signal S2 transmitted by one of the first and second vehicle-mounted transceiver nodes 12, 13.

The vehicle V comprises a display screen 19 (shown in FIG. 2) on which the images received from the vehicle-mounted camera C_{V} and the trailer-mounted camera C_{T} may be selectively displayed. Moreover, the image processor 5 may be configured to combine the vehicle image data D_{V} and the trailer image data D_{T} to form a composite image (not shown). To form the composite image, the image processor 5 may, for example, overlay a portion of the image from the vehicle-mounted camera C_{V} onto the image from the trailer-mounted camera C_{T}. In this embodiment the image processor 5 utilises the determined offset of the tracking module 15 to help align the images from the vehicle-mounted camera C_{V} and the trailer-mounted camera C_{T}.

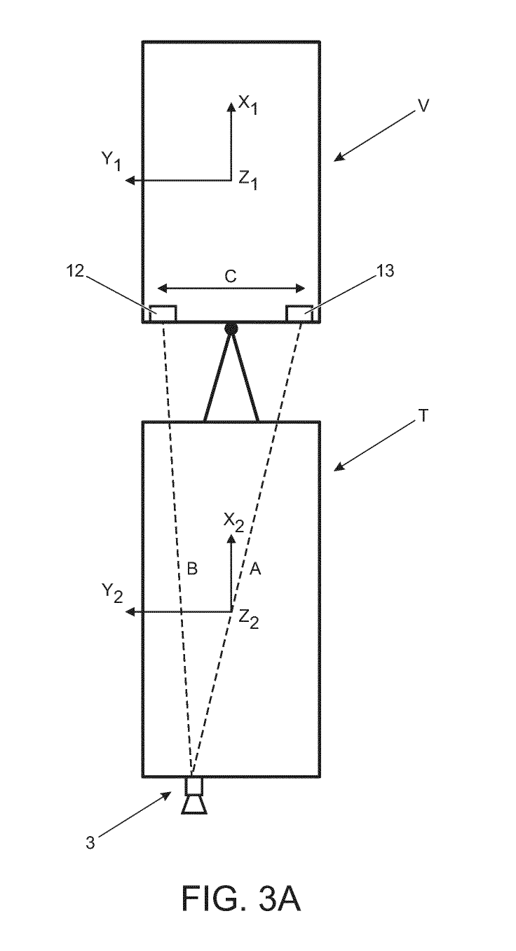

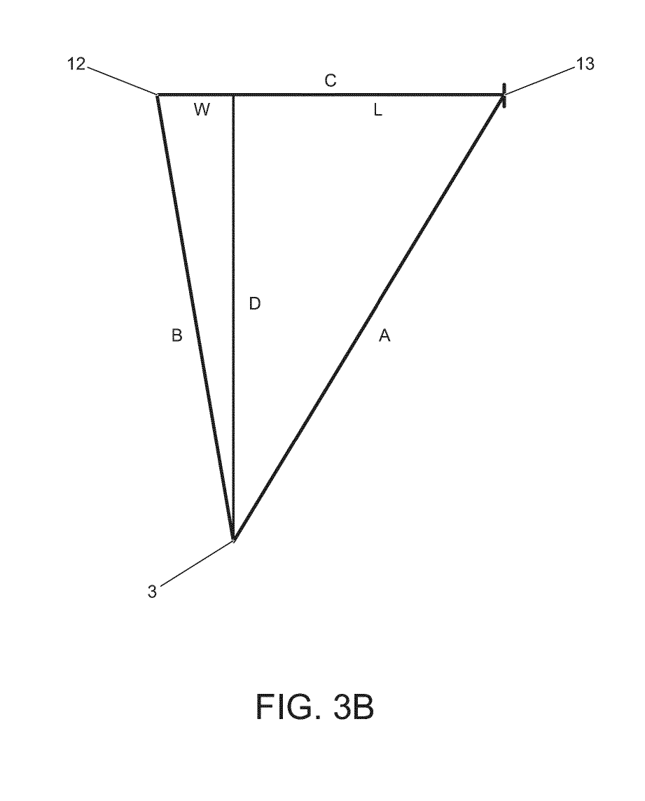

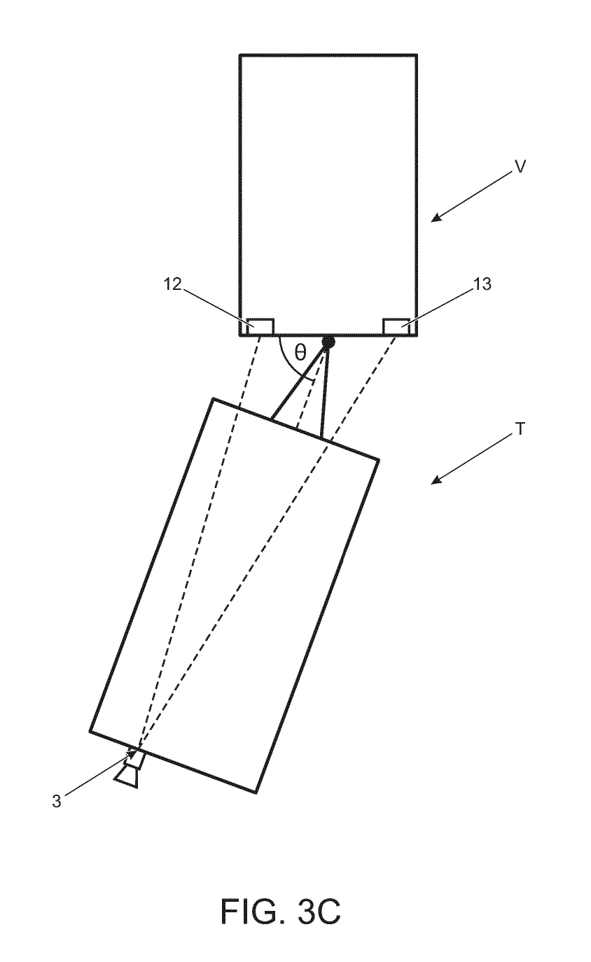

The operation of the vehicle imaging system 1 will now be described with reference to FIGS. 3A-C. The signal processor 11 outputs an activation signal S1 to request the first vehicle-mounted transceiver node 12 to transmit a trigger signal S2. The trigger signal S2 is received by the remote receiver 17 and the remote transmitter 16 responds by transmitting the tracking signal S3. The tracking signal S3 is received by the first and second vehicle-mounted transceiver nodes 12, 13. The time elapsed between transmission of the trigger signal S2 and receipt of the tracking signal S3 at each of the first and second vehicle-mounted transceiver nodes 12, 13 is measured. The time-of-flight of the respective signals is used to determine the distances between the respective first and second vehicle-mounted transceiver nodes 12, 13 and the tracking module 15. With reference to FIGS. 3A and 3B, the location determining module 10 determines a first distance A between the first vehicle-mounted transceiver node 12 and the tracking module 15; and a second distance B between the second vehicle-mounted transceiver node 13 and the tracking module 15. A third distance C corresponding to the lateral offset between the first and second vehicle-mounted transceiver nodes 12, 13 is predefined. The location determining module 10 implements a triangulation algorithm to determine the relative location of the tracking module 15 in dependence on said first, second and third distances A, B, C. Thus, the location determining module 10 determines the static lateral offset Y_{OFF} of the tracking module 15. Furthermore, the location determining module 10 may determine a trailer length D. The trailer length D is useful in automating towing of the trailer T.

The vehicle imaging system 1 may calibrated when the first and second longitudinal axes X₁, X₂ are at least substantially aligned with each other, as illustrated in FIG. 3A. For example, the vehicle imaging system 1 may be activated once the vehicle V has driven in a straight line for a predetermined distance. The vehicle imaging system 1 can be re-calibrated while the vehicle V is moving. It will be appreciated that, once the relative location of the remote imaging apparatus 3 has been determined, the vehicle imaging system 1 can be used to monitor a dynamic hitch angle θ of the trailer T, as illustrated in FIG. 3C. The dynamic hitch angle θ corresponds to an angular offset between the first and second longitudinal axes X₁, X₂ in a horizontal (XY) plane and may be referred to as a yaw angle of the trailer T. The dynamic hitch angle θ can be used to allow the path of the trailer T to be predicted; and/or to implement dynamic control of the trailer T.

The static lateral offset Y_{OFF} facilitates blending or stitching of the image generated by the trailer-mounted camera C_{T} with images from other cameras, such as the vehicle-mounted camera C_{V}. The static lateral offset Y_{OFF} can at least provide a feed forward starting point for an image matching algorithm implemented by the image processor 5. The image processor 5 may utilise the static lateral offset Y_{OFF} to modify the trailer image data D_{T} to implement an image correction function. The image modification can comprise one or more of the following transforms: image rotation, scaling, cropping, magnification (zooming), skew correction and translation. The transform(s) may be applied in two dimensions (2D) or three dimensions (3D), for example to compensate for an angular offset. In addition, or alternatively, the image processor 5 may use the dynamic hitch angle θ to modify the trailer image data D_{T}, for example to form a composite image.

It will be appreciated that various changes and modifications can be made to the image system 1 described herein without departing from the present invention. In the embodiment described herein, the first and second vehicle-mounted transceiver nodes 12, 13 are offset from each other in a lateral direction such that the vehicle imaging apparatus 2 may determine a static lateral offset Y_{OFF} of the remote imaging apparatus 3 from the second longitudinal axis X₂. Alternatively or in addition, the vehicle imaging apparatus 2 may be configured to determine a vertical position of the trailer-mounted camera C_{T}. For example, the first and second vehicle-mounted transceiver nodes 12, 13 may be offset from each other in a vertical direction.

It will be appreciated that there can be more than two vehicle-mounted transceiver nodes 12, 13 to determine the relative location of the remote imaging apparatus 3. As shown in phantom in FIG. 2, a third transceiver node 20 may be provided to determine a vertical location of the remote imaging apparatus 3. The third transceiver node 20 may be disposed at a different height from the first and second vehicle-mounted transceiver nodes 12, 13. The use of three (3) vehicle-mounted transceiver nodes may allow the lateral location and the vertical location of the remote imaging apparatus 3 to be determined. This may allow the determination of a static vertical location of the remote imaging apparatus 3; and/or a dynamic pitch angle of the trailer T. The static vertical location and the dynamic pitch angle may be used in aligning the image generated by the trailer-mounted camera C_{T} with images from the vehicle-mounted camera C_{V}, for example to enable blending of the images. The dynamic pitch angle may be used for dynamic control of the trailer stability. It will be understood that more than three (3) vehicle-mounted transceiver nodes may be provided to improve accuracy.

The vehicle imaging system 1 has been described with reference to a trailer-mounted camera C_{T} and a vehicle-mounted camera C_{V}. The vehicle imaging system 1 may comprise more than one vehicle-mounted camera C_{V}, for example first and second lateral vehicle-mounted cameras. The vehicle imaging system 1 may comprise more than one trailer-mounted camera C_{T}, for example first and second lateral trailer-mounted cameras.

The trailer-mounted camera C_{T} may be fixedly mounted to the trailer T or may be removably mounted. In alternate applications, the methods and apparatus described herein may be used in conjunction with a fully mobile camera (not shown). The fully mobile camera may be a hand-held device or may be mounted to another vehicle.

The remote transmitter 16 has been described as being integrated into the remote imaging apparatus 3. In an alternate embodiment, the remote transmitter 16 may be a separate device which may be positioned adjacent to the remote imaging apparatus 16 to enable determination of the relative location of the remote imaging apparatus 16. The remote transmitter 16 may, for example, be incorporated into an electronic key (such as a key fob) associated with the vehicle V. The electronic key may be the electronic key used to control locking/unlocking of the vehicle and/or activation of the vehicle ignition.

1. A vehicle imaging apparatus for use in a vehicle towing a trailer, the vehicle imaging apparatus comprising:
a location determining module for determining a relative location of a remote imaging apparatus mounted to the trailer, the location determining module being configured to receive a tracking signal from a remote transmitter associated with the remote imaging apparatus;
an image receiver module for receiving image data transmitted by the remote imaging apparatus; and
at least one image processor for processing the image data in dependence on the determined location of the remote imaging apparatus.

2. The vehicle imaging apparatus as claimed in claim 1, further comprising first and second vehicle-mounted receivers;
wherein the location determining module comprises a signal processor for measuring time-of-flight of the tracking signal transmitted by the remote transmitter to the first and second vehicle-mounted receivers, and for determining the relative location of the remote imaging apparatus in dependence on the time-of-flight of the tracking signal transmitted to the first and second vehicle-mounted receivers.

3. The vehicle imaging apparatus as claimed in claim 2, wherein the signal processor is configured to determine a lateral location of the remote imaging apparatus in dependence on the tracking signal.

4. The vehicle imaging apparatus as claimed in claim 2, further comprising a third vehicle-mounted receiver, and wherein the signal processor is configured to measure time-of-flight of the tracking signal transmitted by the remote transmitter to the third vehicle-mounted receiver.

5. The vehicle imaging apparatus as claimed in claim 4, wherein the signal processor is configured to determine a vertical location of the remote imaging apparatus in dependence on the time-of-flight of the tracking signal transmitted to the first, second and third vehicle-mounted receivers.

6. The vehicle imaging apparatus as claimed in claim 1, wherein the at least one image processor is configured to form a composite image comprising the image data.

7. The vehicle imaging apparatus as claimed in claim 6, wherein the at least one image processor is configured to combine the image data with image data from one or more vehicle-mounted camera.

8. The vehicle imaging apparatus as claimed in claim 1, wherein the location determining module is operable to determine a relative orientation of the remote imaging apparatus, and/or a hitch angle of the trailer relative to the vehicle in dependence on the determined relative location of the remote imaging apparatus.

9. (canceled)

10. The vehicle imaging apparatus as claimed in claim 1, wherein the at least one image processor is configured to output the image data to a display device.

11. A vehicle comprising the vehicle imaging apparatus claim 1.

12-14. (canceled)

15. A remote imaging apparatus for mounting to a trailer configured for coupling to a vehicle, the remote imaging apparatus comprising:
a camera;
an image transmitter for transmitting image data generated by the camera; and
a location determining module comprising:
a locating receiver configured to receive at least first and second signals from respective first and second vehicle-mounted transmitters; and
at least one processor for determining a location of the remote imaging apparatus relative to the first and second vehicle-mounted transmitters.

16-18. (canceled)

19. A method of modifying image data for output to a display device disposed in a vehicle towing a trailer, the method comprising:
determining a relative location of a remote imaging apparatus mounted to the trailer;
receiving image data generated by the remote imaging apparatus; and
processing the image data in dependence on the determined relative location of the remote imaging apparatus.

20. The method as claimed in claim 19, wherein determining the relative location of the remote imaging apparatus comprises using first and second vehicle-mounted receivers to receive a tracking signal transmitted by a remote transmitter associated with the remote imaging apparatus.

21. The method as claimed in claim 20, further comprising determining a lateral location of the remote imaging apparatus or a vertical location of the remote imaging apparatus.

22-26. (canceled)

27. The vehicle imaging apparatus as claimed in claim 1, wherein the vehicle imaging apparatus is configured to determine the relative location of the remote imaging apparatus once the vehicle has travelled a predetermined distance.

28. The vehicle imaging apparatus as claimed in claim 27, wherein the vehicle imaging apparatus determines the relative location of the remote imaging apparatus when the vehicle has travelled in a substantially straight line for the predetermined distance.

29. The vehicle imaging apparatus as claimed in claim 1, wherein the location determining module is configured to transmit a trigger signal to the remote imaging apparatus.

30. The method as claimed in claim 19, wherein the relative location of the remote imaging apparatus is determined once the vehicle has travelled a predetermined distance.

31. The method as claimed in claim 30, further comprising determining the relative location of the remote imaging apparatus when the vehicle has travelled in a substantially straight line for said predetermined distance.

32. The method as claimed in claim 19, further comprising transmitting a trigger signal to the remote imaging apparatus, and wherein the tracking signal is transmitted in dependence on receipt of the trigger signal.
